(19) United States
(12) Patent Application Publication
(10) Pub. No.: US 2024/0023569 A1
(43) Pub. Date: Jan. 25, 2024

(54) NUT BLENDS FOR NUT BASED BEVERAGE

(71) Applicants: Dane Turk, Columbus, OH (US); Alicia Long, Columbus, OH (US)

(72) Inventors: Dane Turk, Columbus, OH (US); Alicia Long, Columbus, OH (US)

(21) Appl. No.: 18/351,290

(22) Filed: Jul. 12, 2023

Related U.S. Application Data
(60) Provisional application No. 63/388,814, filed on Jul. 13, 2022.

(51) Int. Cl. A23C 11/10; A23L 33/105; A23L 33/175; A23L 33/15; A23L 33/16; A23L 29/00

(52) U.S. Cl. CPC A23C 11/103; A23L 33/105; A23L 33/175; A23L 33/15; A23L 33/16; A23L 29/06

(57) ABSTRACT

A nut blend for nut milk comprises a first nut base combinable with a second flavor base. The second flavor base (FB) can be selected from a composition consisting of one or more of a flavor profile/sweetener (V), a functional nutrition supplement (W) (i.e. superfood or adaptogen), and vitamins/minerals (X). In one exemplary arrangement, the flavor profile/sweetener (V) can comprise 30%-90% by weight of the flavor base; the nutrition supplement (W) can comprise 5%-65% by weight of the flavor base; and, the vitamins/minerals (X) can comprise 4%-10% by weight of the flavor base. The second flavor base can be packaged in a separate individual package or packet. The first nut base can be packaged in another separate individual package or packet. When desired, a selectable flavor base packet can be combined with a specified quantity or packet from a selectable nut base, according to user preferences.

### CROSS-REFERENCE TO RELATED APPLICATION

The present application claims priority to, and the benefit of, U.S. Provisional Application No. 63/388,814, which was filed on Jul. 13, 2022, and is incorporated herein by reference in its entirety.

### FIELD OF INVENTION

A novel nut blend for nut milk as described herein, which incorporates separate ingredients to be incorporated into a single nut blend mixture. A first nut base (NB), for example, a beverage base/liquid base is combinable with a second flavor base (FB). The first nut base can be selected from a group consisting of an almond tree nut, an oat nut, a cashew tree nut, and a hemp seed. The second flavor base can be selected from a composition consisting of one or more of a flavor profile/sweetener, a functional nutrition supplement (i.e. superfood), and vitamins/minerals. The flavor profile can be selected from one or more of the following: a spice/sweetener including, but not limited to, a chocolate, a vanilla, a matcha, a coconut, a cinnamon, a salted caramel, a ginger, a cocoa, a monk fruit sugar, a coconut sugar, a cinnamon latte, a cacao nib, a date sugar, a turmeric, a coffee, a strawberry, an elderberry, an acai berry, and a goji berry. The functional nutrition supplement can be selected from one or more of the following: a lion's mane mushroom, a chlorella, a spirulina, a maca root, an ashwagandha root, a cordyceps mushroom, a chaga mushroom, a tocotrienols, a tocophorels, a reishi mushroom, an astragalus root, a chamomile, an L-Theanine, and a mucuna seed. The vitamins/minerals can be selected from one or more of the following: vitamin D, probiotic, vitamin C, magnesium, zinc, vitamin B, calcium, digestive enzymes, fiber, phosphorus, potassium, sodium, chloride, iron, iodine, sulfur, cobalt, copper, fluoride, manganese, calcium citrate, magnesium glycinate, vitamin D3, vitamin K2, zinc oxide, thiamin, niacin, vitamin B6, vitamin B12, vitamin E, and selenium.

The present invention relates generally to the field of nut blends for nut milk that can be selectively used in conjunction with mixing machines and blenders. More specifically, the present invention relates to a variety of nut blends compatible with an improved mixing machine with particular settings and mixing functions for making different varieties of nut milk and different concoctions using nut milk. The mixing machine includes combinations of temperature settings, blending speeds, filters, and/or blending durations to enable a variety of different nut milk blends and nut milk concoctions. The improved mixing machine enables predeterminable settings to achieve the desired blended varieties. Additionally, the improved mixing machine enables the users to predetermine a particular nut milk blend for a pre-selectable combination of blend duration and temperature settings. Accordingly, the present disclosure makes specific reference thereto. Nonetheless, it is to be appreciated that aspects of the present invention are also equally applicable to other like applications, devices, and methods of manufacture.

### BACKGROUND OF THE INVENTION

The novel nut blend for nut milk comprises a first nut base combinable with a second flavor base. The second flavor base (FB) can be selected from a composition consisting of one or more of a flavor profile/sweetener (V), a functional nutrition supplement (W) (i.e. superfood or adaptogen), and vitamins/minerals (X). In one exemplary arrangement, the flavor profile/sweetener (V) can comprise 30%-90% by weight of the flavor base; the nutrition supplement (W) can comprise 5%-65% by weight of the flavor base; and, the vitamins/minerals (X) can comprise 4%-10% by weight of the flavor base. The second flavor base can be packaged in a separate individual package or packet. The first nut base can be packaged in another separate individual package or packet. When desired, a selectable flavor base packet can be combined with a specified quantity from a selectable nut base, according to user preferences.

By way of background, various kinds of mixers and blenders are used by individuals to mix and blend ingredients (i.e. liquids, solids, and semi-solids) to create edible mixtures and concoctions for consumption. Conventional mixers combine a speed setting (i.e. mixing blade speed) and a function setting to enable a user to achieve a desired blending result. Temperature of the mixed ingredients is typically serendipitously established by reaching an ‘equilibrium’ temperature based on the volume and temperature of the respective ingredients placed into a blender container and mixed therein. Thus, typical blenders cannot establish a desired or predeterminable temperature of the final blended composition with a programmed setting; but rather, the ingredients default to an ‘equilibrium’ temperature that is reached based on the temperature and volume of the respective individual ingredients. Various solutions are available in the state of the art to allow users to blend or mix ingredients. For example, some blenders provide mixing capabilities for large quantities, while other blenders can include a volume suited for single servings. However, heretofore known blenders are not suited for single serving preparations of nut milk that is extracted from nuts and blended to a predeterminable temperature and consistency. An efficient, programmable, and portable mixer is therefore desired by the users.

### SUMMARY OF INVENTION

Formulations and manufacturing procedures for product (P) comprise a novel nut milk blend including a multitude of selectable nut bases, wherein each nut base is blendable with a multitude of selectable flavor bases. P has enhanced health benefits, shelf life, variety, and taste compared to the existing nut milks heretofore known. P serves as a novel, improved, and general method for blending or mixing nut milks incorporating nut bases and flavor bases. P is defined by equation [i].

P=nut base (NB)+flavor base (FB) [i]

The first nut base (NB) includes, but is not limited to, almonds, oats, cashews, and hemp seeds. Either one of the nuts or seeds or a combination of two or more types of nuts or seeds or mixtures of nuts and seeds may be used. The second flavor base (FB) can be selected from a composition consisting of one or more of a flavor profile/sweetener (V), a functional nutrition supplement (i.e. superfood) (W), and vitamins/minerals (X).

The flavor profile/sweetener (V=none), one or more of spices or sweeteners including, but not limited to, a chocolate, a vanilla, a matcha, a coconut, a cinnamon, a salted caramel, a ginger, a flaxseed, a cocoa, a monk fruit sugar, a monk fruit 25% extract, a coconut sugar, a cocoa nib, pink Himalayan salt, coconut milk, cacao nibs, cacao powder, mucuna seed powder, turmeric, black pepper, coffee, chamomile extract, strawberry powder, acai berry powder, elderberry powder, goji berry powder, and a date sugar; powdered or ground form or as a paste or mixtures thereof.

The functional nutrition supplement (W=none), one or more of supplements including, but not limited to, a lion's mane mushroom, a chlorella, a spirulina, a maca root, an ashwagandha, a cordyceps mushroom, a chaga mushroom, tocotrienols (i.e. tocos), a tocophorel, a reishi mushroom, an astragalus root, a chamomile, an L-Theanine, and a mucuna seed; powdered or ground form or as a paste or mixtures thereof.

The vitamins/minerals (X=none), one or more of vitamins/minerals including, but not limited to, vitamin D, probiotic, vitamin C, magnesium, zinc, vitamin B, calcium, digestive enzymes, fiber, phosphorus, potassium, sodium, chloride, iron, iodine, sulfur, cobalt, copper, fluoride, manganese, calcium citrate, magnesium glycinate, vitamin D3, vitamin K2, zinc oxide, thiamin, niacin, vitamin B6, vitamin B12, vitamin E, and selenium; powdered or ground form or as a paste or mixtures thereof.

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a blender or mixing machine, including a selectable speed, a temperature setting, and/or a duration setting to reach a desired temperature and blending consistency. In one potential embodiment, the mixing machine includes distinct temperature settings of no heat, warm heat, and hot heat. As a part of the blending and heating cycles, the mixing machine can run, mix, or blend for predefined periods to reach a selectable desired temperature (i.e. minimum temperature) and blending setpoints. The selectable heat and blending settings enable particular varieties of nut blends for nut milk and particular concoctions therefrom to be blended.

In one potential embodiment, the mixing machine comprises a blender configured for a single serving nut milk variety mixture. Exemplary volumes include ranges from about 4 ounces to about 24 ounces per cycle of the mixing machine. The exemplary volumes, and others therebetween, can be enabled with interior marked fill lines (i.e. min and max fill lines) in an interior of a mixing container or blender body. The serving volume of the unit can be modified based on the preference of the user. In one potential embodiment, the mixer or nut blender for making nut milk comprises: a mixer including a cap or lid, a blender body, a mixing blade configuration, a filter(s), and a heating element for blending nuts and heating ingredients within the blender body; and, a plurality of mixer controls including a variety of pre-selectable settings for simultaneous blend duration and temperature setting. The plurality of mixer controls include at least three settings: wherein a first setting includes a first blend duration and a first heat setting; a second setting includes a second blend duration and a second heat setting; and, a third setting includes a third blend duration and a third heat setting. The second heat setting can be greater than the first heat setting, and the third heat setting can be greater than the second heat setting. In other embodiments, the second blend duration can be greater than the first blend duration, and the third blend duration can be greater than the second blend duration. The first heat setting can be zero and the first blend duration can be less than or equal to 2 minutes. The second heat setting can be less than or equal to 70 degrees C. and the second blend duration can be less than or equal to 6 minutes. The third heat setting can be less than or equal to 120 degrees C. and the third blend duration can be less than or equal to 20 minutes.

In still further embodiments, the nut blender comprises a single serving quantity from about 4 ounces to about 24 ounces. A removable internal filter can be integrated with the blender body for filtering nut pulp from the nut milk. The filter can be situated between the cap and the blender body. The filter, in one embodiment, includes a mesh size from about 50 microns to about 250 microns. The filter, in another embodiment, includes a mesh size from about 50 microns to about 1000 microns. Still further, the mixing machine can include a selectively removable filtration device for minimizing the amount of pulp in the consumable product or final mixture. The mixing machine can include an external and/or an internal filtration unit, or perforated device, selectively actuated by the user as desired for optimal pulp removal or straining in the final product or mixture. The filtration unit can comprise a specific wire mesh size, or perforation size, in order to allow the milk to pass or strain therethrough, while capturing nut pulp, dried fruit pieces, and other particulates from the blended concoction.

The mixing machine can further include a blender body comprising a stainless-steel interior and a plastic or polymer exterior. An electric power unit powers a motor for turning the blender blades. The motor also powers a heating element for selective heat settings to heat the ingredients placed and blended within the blender body. The electric power unit can include an electric cord and plug for connecting to an electric source or circuit including, for example, a 110V/60 HZ input or 220V-240V/50 HZ input power. The mixing machine further includes a cover for protecting the electronics therein. To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a flow diagram depicting a method of making a nut milk blend of the present invention in accordance with the disclosed architecture;

FIG. 2 illustrates a flow diagram depicting another method of making a nut milk blend of the present invention in accordance with the disclosed architecture; and

FIG. 3 illustrates a flow diagram of yet still another method of making a nut milk blend of the present invention in accordance with the disclosed architecture.

### DETAILED DESCRIPTION OF THE PRESENT INVENTION

P=the product obtained, including a separate nut base (NB) and a separate flavor base (FB), as described above, can be blended or mixed together to form a nut milk beverage.

The blending or mixing process can include approaches in which the nuts and/or seeds of the NB are ground or mixed in a blending, grinding, milling, chopping or nut milk producing machine or any another mixing machine that breaks down the ingredients. It should be noted that the other ingredients of the FB can be one or more of V, W, and/or X. In one equation, the NB can be premade into a nut milk and then mixed/blended with the FB. The blending or mixing process can involve optional heating of one or more of the ingredients. The nut milk producing machine can be electrically operated and comprise at least a pair of mixing blades for grinding nuts and blending the nut base with the flavor base.

In one embodiment the NB and the FB are packaged separately, and sold together in a unit. Thus, users can select a particular NB and a particular FB to form a solution or combination to suit the desires of the user.

Exemplary formulations for the FB are described below:

Formulation#1
(i.e. Matcha)

| | AMT | | AMT | | AMT | | |
|---|---|---|---|---|---|---|---|
| | (g) | | (oz.) | | (lb) | | Ingredient |
| 29.61% | 2.250 | g | 0.079 | oz | 0.0050 | lb | Matcha Powder |
| 3.03% | 0.230 | g | 0.008 | oz | 0.0005 | lb | Spirulina Powder |
| 11.18% | 0.850 | g | 0.030 | oz | 0.0019 | lb | Maca Root Powder |
| 9.87% | 0.750 | g | 0.026 | oz | 0.0017 | lb | Lion's Mane Mushroom |
| | | | | | | | Powder |
| 3.95% | 0.300 | g | 0.011 | oz | 0.0007 | lb | Cinnamon Powder |
| 39.47% | 3.000 | g | 0.106 | oz | 0.0066 | lb | Date Sugar |
| 2.63% | 0.200 | g | 0.007 | oz | 0.0004 | lb | Pink Himalayan Salt |
| 0.26% | 0.020 | g | 0.001 | oz | 0.0000 | lb | Monk Fruit 25% Extract |
| | | | | | | | Powder |
| Total | 7.60 | g | 0.268 | oz | 0.0168 | lb | |

Formulation #2
(i.e. Cookies + Cream)

| | AMT | | AMT | | AMT | | |
|---|---|---|---|---|---|---|---|
| | (g) | | (oz.) | | (lb) | | Ingredient |
| 5.65% | 1.00 | g | 0.035 | Oz | 0.0022 | lb | Vanilla Extract Powder |
| 1.02% | 0.18 | g | 0.006 | Oz | 0.0004 | lb | Cinnamon Powder |
| 7.34% | 1.30 | g | 0.046 | Oz | 0.0029 | lb | Ashwagandha Root |
| | | | | | | | Powder |
| 5.65% | 1.00 | g | 0.035 | Oz | 0.0022 | lb | Cordyceps Mushroom |
| | | | | | | | Powder |
| 5.65% | 1.00 | g | 0.035 | Oz | 0.0022 | lb | Chaga Mushroom |
| | | | | | | | Powder |
| 28.25% | 5.00 | g | 0.176 | Oz | 0.0110 | lb | Tocos |
| 11.30% | 2.00 | g | 0.071 | Oz | 0.0044 | lb | Coconut Milk Powder |
| 16.95% | 3.00 | g | 0.106 | Oz | 0.0066 | lb | Cacao Nibs |
| 16.95% | 3.00 | g | 0.106 | Oz | 0.0066 | lb | Date Sugar |
| 1.13% | 0.20 | g | 0.007 | Oz | 0.0004 | lb | Pink Himalayan Salt |
| 0.11% | 0.02 | g | 0.001 | Oz | 0.0000 | lb | Monk Fruit 25% Extract |
| | | | | | | | Powder |
| Total | 17.70 | g | 0.624 | Oz | 0.0390 | lb | |

Formulation #3
(i.e. Vanilla)

| | AMT | | AMT | | AMT | | |
|---|---|---|---|---|---|---|---|
| | (g) | | (oz.) | | (lb) | | Ingredient |
| 8.24% | 1.05 | g | 0.037 | Oz | 0.0023 | lb | Vanilla Extract Powder |
| 1.41% | 0.18 | g | 0.006 | Oz | 0.0004 | lb | Cinnamon Powder |
| 10.20% | 1.30 | g | 0.046 | Oz | 0.0029 | lb | Ashwagandha Root |
| | | | | | | | Powder |
| 7.84% | 1.00 | g | 0.035 | Oz | 0.0022 | lb | Cordyceps Mushroom |
| | | | | | | | Powder |
| 7.84% | 1.00 | g | 0.035 | Oz | 0.0022 | lb | Chaga Mushroom |
| | | | | | | | Powder |
| 39.22% | 5.00 | g | 0.176 | Oz | 0.0110 | lb | Tocos Powder |
| 23.53% | 3.00 | g | 0.106 | Oz | 0.0066 | lb | Date Sugar |
| 1.57% | 0.20 | g | 0.007 | Oz | 0.0004 | lb | Pink Himalayan Salt |
| 0.16% | 0.02 | g | 0.001 | Oz | 0.0000 | lb | Monk Fruit 25% |
| | | | | | | | Extract Powder |
| Total | 12.75 | g | 0.450 | Oz | 0.0281 | lb | |

Formulation #4
(i.e. Ginger + Turmeric)

| | AMT | | AMT | | AMT | | |
|---|---|---|---|---|---|---|---|
| | (g) | | (oz.) | | (lb) | | Ingredient |
| 26.89% | 2.42 | g | 0.085 | Oz | 0.0053 | lb | Turmeric Powder |
| 1.67% | 0.15 | g | 0.005 | Oz | 0.0003 | lb | Black Pepper |
| 7.22% | 0.65 | g | 0.023 | Oz | 0.0014 | lb | Ginger Powder |
| 4.00% | 0.36 | g | 0.013 | Oz | 0.0008 | lb | Cinnamon |
| 7.22% | 0.65 | g | 0.023 | Oz | 0.0014 | lb | Reishi Mushroom |
| | | | | | | | Powder |
| 5.56% | 0.50 | g | 0.018 | Oz | 0.0011 | lb | Astragalus Root |
| | | | | | | | Powder |
| 47.22% | 4.25 | g | 0.150 | Oz | 0.0094 | lb | Date Sugar |
| 0.22% | 0.02 | g | 0.001 | Oz | 0.0000 | lb | Monk Fruit 25% |
| | | | | | | | Extract Powder |
| Total | 9.00 | g | 0.317 | Oz | 0.0198 | lb | |

Formulation #5
(i.e. Coffee)

| | AMT | | AMT | | AMT | | |
|---|---|---|---|---|---|---|---|
| | (g) | | (oz.) | | (lb) | | Ingredient |
| 31.30% | 2.88 | g | 0.102 | Oz | 0.0063 | lb | Instant Coffee |
| 5.43% | 0.50 | g | 0.018 | Oz | 0.0011 | lb | Maca Powder |
| 7.61% | 0.70 | g | 0.025 | Oz | 0.0015 | lb | Vanilla Extract Powder |
| 21.74% | 2.00 | g | 0.071 | Oz | 0.0044 | lb | Coconut Milk Powder |
| 31.20% | 2.87 | g | 0.101 | Oz | 0.0063 | lb | Date Sugar |
| 0.54% | 0.05 | g | 0.002 | Oz | 0.0001 | lb | Cinnamon |
| 2.17% | 0.20 | g | 0.007 | Oz | 0.0004 | lb | Pink Himalayan Salt |
| Total | 9.20 | g | 0.325 | Oz | 0.0203 | lb | |

Formulation #6
(i.e. Coconut)

| | AMT | | AMT | | AMT | | |
|---|---|---|---|---|---|---|---|
| | (g) | | (oz.) | | (lb) | | Ingredient |
| 38.04% | 3.50 | g | 0.123 | Oz | 0.0077 | lb | Coconut Milk Powder |
| 16.30% | 1.50 | g | 0.053 | Oz | 0.0033 | lb | Chamomile Extract |
| 10.87% | 1.00 | g | 0.035 | Oz | 0.0022 | lb | Reishi Mushroom |
| 32.61% | 3.00 | g | 0.106 | Oz | 0.0066 | lb | Date Sugar |
| 2.17% | 0.20 | g | 0.007 | Oz | 0.0004 | lb | L-Theanine Powder |
| Total | 9.20 | g | 0.325 | Oz | 0.0203 | lb | |

Formulation #7
(i.e. Chocolate)

| | AMT | | AMT | | AMT | | |
|---|---|---|---|---|---|---|---|
| | (g) | | (oz.) | | (lb) | | Ingredient |
| 38.38% | 3.55 | g | 0.125 | Oz | 0.0078 | lb | Cacao Powder |
| 8.11% | 0.75 | 00 | 0.026 | Oz | 0.0017 | lb | Ashwagandha Root |
| | | | | | | | Powder |
| 8.11% | 0.75 | g | 0.026 | Oz | 0.0017 | lb | Mucuna Seed Powder |
| 37.84% | 3.50 | g | 0.123 | Oz | 0.0077 | lb | Date Sugar |
| 3.24% | 0.30 | g | 0.011 | Oz | 0.0007 | lb | Pink Himalayan Salt |
| 4.32% | 0.40 | g | 0.014 | Oz | 0.0009 | lb | Vanilla Extract Powder |
| 0.22% | 0.02 | g | 0.001 | Oz | 0.0000 | lb | Monk Fruit 25% Extract |
| | | | | | | | Powder |
| Total | 9.25 | g | 0.326 | Oz | 0.0204 | lb | |

Formulation #8
(i.e. Berry)

| | AMT | | AMT | | AMT | | |
|---|---|---|---|---|---|---|---|
| | (g) | | (oz.) | | (lb) | | Ingredient |
| 32.73% | 3.60 | g | 0.127 | Oz | 0.0079 | lb | Strawberry Powder |
| 27.27% | 3.00 | g | 0.106 | Oz | 0.0066 | lb | Acai Berry Powder |
| 18.18% | 2.00 | g | 0.071 | Oz | 0.0044 | lb | Elderberry Powder |
| 18.18% | 2.00 | g | 0.071 | Oz | 0.0044 | lb | Goji Berry Powder |
| 1.36% | 0.15 | g | 0.005 | Oz | 0.0003 | lb | Monk Fruit 25% Extract |
| | | | | | | | Powder |
| 2.27% | 0.25 | g | 0.009 | Oz | 0.0006 | lb | Pink Himalayan Salt |
| Total | 11.00 | g | 0.388 | Oz | 0.0243 | lb | |

As stated supra, the second flavor base (FB) can be selected from a composition consisting of a flavor profile/sweetener (V); a functional nutrition supplement (i.e. superfood) (W); and/or vitamins/minerals (X). In one exemplary arrangement, the flavor sweetener V can comprise from about 30% to about 90% of the FB; the nutrition supplement W can comprise from about 5% to about 65% of the FB; and, the vitamins/minerals X can comprise from about 4% to about 10% of the FB.

The invention involves compositions of raw or roasted nuts or seeds in ground, powdered, crunchy, smooth, paste, whole, crushed, broken, mixed, blended, or slurry form; the nut/seed component is called nut base NB component (the nuts, including but not limited to, almonds, oats, cashews, and hemp seeds). Either one of the nuts or seeds or a combination of two or more types of nuts or seeds or mixtures of nuts and seeds may be used. Further, the nut base can include a texture altering additive to form an enzymatic blend, wherein the additive is selected from a group consisting of a cellulase, a protease A, a lipase, and an amylase A (2500 DU).

Either one of the nuts or seeds, or a combination of two or more types of nuts or seeds, may be blended/ground to form Component NB. Component NB can further be combined with Component V, Component W, and/or Component X to form product P. Exemplary compositions (i.e., compositions of A-G) of product P are detailed below.

The composition of components NB and V is referred to as composition A. Composition A=a composition of NB mixed with one or more flavor profile/sweetener V; wherein V including one or more of spices or sweeteners including, but not limited to, a chocolate, a vanilla, a matcha, a coconut, a cinnamon, a salted caramel, a ginger, a flaxseed, a cocoa, a monk fruit sugar, a coconut sugar, a cocoa nib, pink Himalayan salt, coconut milk, cacao nibs, cacao powder, mucuna seed powder, turmeric, black pepper, coffee, chamomile extract, strawberry powder, acai berry powder, elderberry powder, goji berry powder, and a date sugar; powdered or ground form or as a paste or mixtures thereof.

Composition B=a composition of A mixed with one or more of the functional nutrition supplements W; wherein W including, but not limited to, a lion's mane mushroom, a chlorella, a spirulina, a maca root, an ashwagandha root, a cordyceps mushroom, a chaga mushroom, a tocotrienols, a tocophorels, a reishi mushroom, an astragalus root, a chamomile, an L-Theanine, and a mucuna seed; powdered or ground form or as a paste or mixtures thereof.

Composition C=a composition of A mixed with one or more of vitamins/minerals X; wherein X including, but not limited to, vitamin D, probiotic, vitamin C, magnesium, zinc, vitamin B, calcium, digestive enzymes, fiber, phosphorus, potassium, sodium, chloride, iron, iodine, sulfur, cobalt, copper, fluoride, manganese, calcium citrate, magnesium glycinate, vitamin D3, vitamin K2, zinc oxide, thiamin, niacin, vitamin B6, vitamin B12, vitamin E, and selenium; powdered or ground form or as a paste or mixtures thereof.

Composition D=a composition of B mixed with one or more of vitamins/minerals X; wherein X including, but not limited to, vitamin D, probiotic, vitamin C, magnesium, zinc, vitamin B, calcium, digestive enzymes, fiber, phosphorus, potassium, sodium, chloride, iron, iodine, sulfur, cobalt, copper, fluoride, manganese, calcium citrate, magnesium glycinate, vitamin D3, vitamin K2, zinc oxide, thiamin, niacin, vitamin B6, vitamin B12, vitamin E, and selenium; powdered or ground form or as a paste or mixtures thereof.

Composition E=a composition of NB mixed with one or more of the functional nutrition supplements W and with one or more of vitamins/minerals X.

Composition F=a composition of NB mixed with one or more of the functional nutrition supplements W.

Composition G=a composition of NB mixed with one or more of the vitamins/minerals X.

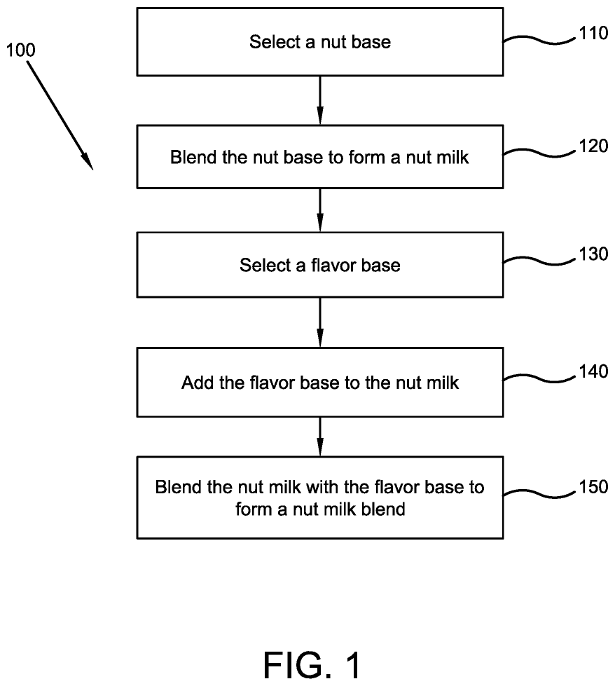

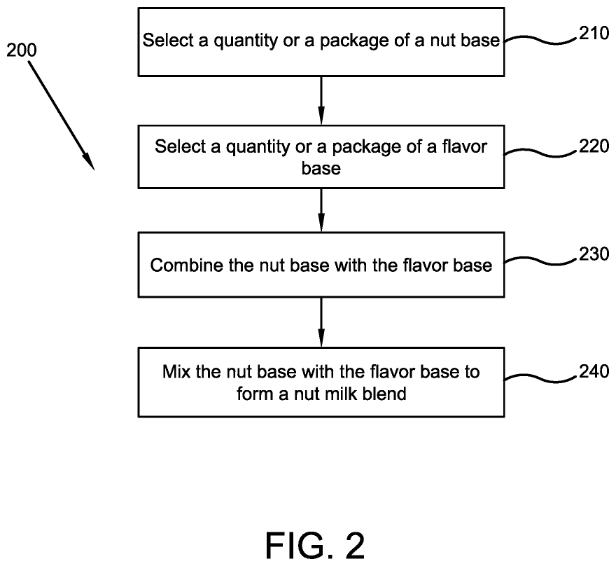

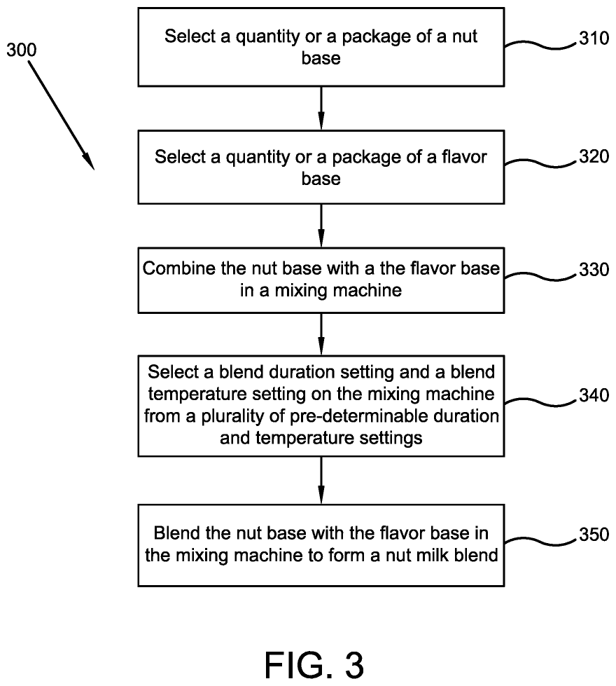

Referring to the figures, FIG. 1 illustrates a flow diagram depicting a method of forming a nut milk blend 100. The method comprising the steps of selecting a nut base (step 110); blending the nut base to form a nut milk (step 120); selecting a flavor base (step 130); adding the flavor base to the nut milk (step 140); and, blending the nut milk with the flavor base to form a nut milk blend (step 150). FIG. 2 illustrates a flow diagram depicting another method of forming a nut milk blend 200. The method comprising the steps of selecting a quantity or a package of a nut base (step 210); selecting a quantity or a package of a flavor base (step 220); combining the nut base and flavor base (step 230); and, mixing the nut base with the flavor base to form a nut milk blend (step 240). FIG. 3 illustrates a flow diagram depicting yet still another method of forming a nut milk blend 300. The method comprising the steps of selecting a quantity or a package of a nut base (step 310); selecting a quantity or a package of a flavor base (step 320); combining the nut base with the flavor base in a mixing machine (step 330); selecting a blend duration setting and a blend temperature setting on the mixing machine having a plurality of pre-determinable duration and temperature settings (step 340); and, blending the nut base with the flavor base in the mixing machine to form a nut milk blend (step 350).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “nut milk”, and “nut milk blend” are interchangeable and refer to the product formed from the methods described in the flow charts of 100, 200, 300.

Various modifications and additions can be made to the exemplary embodiments and methods discussed without departing from the scope of the present invention. While the embodiments and methods described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A nut milk blend composition comprising:
a nut milk blend having a nut base and a flavor base;
wherein said nut base selected from a group consisting of one or more of an almond tree nut, an oat nut, a cashew tree nut, and a hemp seed;
wherein said flavor base selected from a group consisting of one or more of a flavor profile/sweetener (V), a nutrition supplement (W), and a vitamin/mineral (X);
wherein said nut base is in a form selected from a group consisting of ground, powdered, crunchy, smooth, paste, whole, crushed, broken, mixed, blended, and slurry;
wherein said flavor base is in a form selected from a group consisting of ground, powdered, crunchy, smooth, paste, whole, crushed, broken, mixed, blended, and slurry; and
further wherein said nut base blended with said flavor base.

2. The nut milk blend of claim 1, wherein said flavor sweetener is selected from a group consisting of one or more of a chocolate, a vanilla, a matcha, a coconut, a cinnamon, a salted caramel, a ginger, a flaxseed, a cocoa, a monk fruit sugar, a coconut sugar, a cocoa nib, pink Himalayan salt, coconut milk, cacao nibs, cacao powder, mucuna seed powder, turmeric, black pepper, coffee, chamomile extract, strawberry powder, acai berry powder, elderberry powder, goji berry powder, and a date sugar.

3. The nut milk blend of claim 2, wherein said nutrition supplement is selected from a group consisting of one or more of a lion's mane mushroom, a chlorella, a spirulina, a maca root, an ashwagandha root, a cordyceps mushroom, a chaga mushroom, a tocotrienols, a tocophorels, a reishi mushroom, an astragalus root, a chamomile, an L-Theanine, and a mucuna seed.

4. The nut mild blend of claim 3, wherein said vitamin/mineral is selected from a group consisting of one or more of vitamin D, probiotic, vitamin C, magnesium, zinc, vitamin B, calcium, digestive enzymes, fiber, phosphorus, potassium, sodium, chloride, iron, iodine, sulfur, cobalt, copper, fluoride, manganese, calcium citrate, magnesium glycinate, vitamin D3, vitamin K2, zinc oxide, thiamin, niacin, vitamin B6, vitamin B12, vitamin E, and selenium.

5. The nut milk blend of claim 4, wherein said flavor sweetener is from about 30% to about 90% of said flavor base;
wherein said nutrition supplement is from about 5% to about 65% of said flavor base; and
further wherein said vitamin/mineral is from about 4% to about 10% of said flavor base.

6. The nut milk blend of claim 4, wherein said nut base is a first package; and
further wherein said flavor base is a second package.

7. The nut milk blend of claim 6, wherein said flavor base selected from a group consisting of two or more of said flavor profile/sweetener (V), said nutrition supplement (W), and said vitamin/mineral (X).

8. The nut milk blend of claim 6, wherein said flavor base having said flavor profile/sweetener (V), said nutrition supplement (W), and said vitamin/mineral (X).

9. A method of making a nut milk blend, the method comprising the steps of:
selecting a nut base and a flavor base;
wherein said nut base selected from a group consisting of one or more of an almond tree nut, an oat nut, a cashew tree nut, and a hemp seed;
wherein said flavor base selected from a group consisting of one or more of a flavor profile/sweetener (V), a nutrition supplement (W), and a vitamin/mineral (X);
wherein said nut base is in a form selected from a group consisting of ground, powdered, crunchy, smooth, paste, whole, crushed, broken, mixed, blended, and slurry;
wherein said flavor base is in a form selected from a group consisting of ground, powdered, crunchy, smooth, paste, whole, crushed, broken, mixed, blended, and slurry; and
blending said nut base with said flavor base in a mixing machine to form the nut milk blend.

10. The method of claim 9, wherein said flavor sweetener is selected from a group consisting of one or more of a chocolate, a vanilla, a matcha, a coconut, a cinnamon, a salted caramel, a ginger, a flaxseed, a cocoa, a monk fruit sugar, a coconut sugar, a cocoa nib, pink Himalayan salt, coconut milk, cacao nibs, cacao powder, mucuna seed powder, turmeric, black pepper, coffee, chamomile extract, strawberry powder, acai berry powder, elderberry powder, goji berry powder, and a date sugar; and
further wherein said flavor sweetener is in a form selected from a group consisting of a powder, a grinding, and a paste.

11. The method of claim 10, wherein said nutrition supplement is selected from a group consisting of one or more of a lion's mane mushroom, a chlorella, a spirulina, a maca root, an ashwagandha root, a cordyceps mushroom, a chaga mushroom, a tocotrienols, a tocophorels, a reishi mushroom, an astragalus root, a chamomile, an L-Theanine, and a mucuna seed; and
further wherein said nutrition supplement is in a form selected from a group consisting of a powder, a grinding, and a paste.

12. The method of claim 11, wherein said vitamin/mineral is selected from a group consisting of one or more of vitamin D, probiotic, vitamin C, magnesium, zinc, vitamin B, calcium, digestive enzymes, fiber, phosphorus, potassium, sodium, chloride, iron, iodine, sulfur, cobalt, copper, fluoride, manganese, calcium citrate, magnesium glycinate, vitamin D3, vitamin K2, zinc oxide, thiamin, niacin, vitamin B6, vitamin B12, vitamin E, and selenium.

13. The method of claim 12, wherein said flavor sweetener is from about 30% to about 90% of said flavor base;
wherein said nutrition supplement is from about 5% to about 65% of said flavor base; and
further wherein said vitamin/mineral is from about 4% to about 10% of said flavor base.

14. The method of claim 9, further comprising the step of:
adding a texture altering additive to said nut base to form an enzymatic blend, wherein said additive is selected from a group consisting of a cellulase, a protease A, a lipase, and an amylase A.

15. The method of claim 14, wherein said flavor base selected from a group consisting of two or more of said flavor profile/sweetener (V), said nutrition supplement (W), and said vitamin/mineral (X).

16. The method of claim 14, wherein said flavor base having said flavor profile/sweetener (V), said nutrition supplement (W), and said vitamin/mineral (X).

17. A method of making a nut milk blend, the method comprising the steps of:
selecting a nut base in a first package and a flavor base in a second package;
wherein said nut base selected from a group consisting of one or more of an almond tree nut, an oat nut, a cashew tree nut, and a hemp seed;
wherein said flavor base selected from a group consisting of one or more of a flavor profile/sweetener (V), a nutrition supplement (W), and a vitamin/mineral (X);
wherein said nut base is in a form selected from a group consisting of ground, powdered, crunchy, smooth, paste, whole, crushed, broken, mixed, blended, and slurry;
wherein said flavor base is in a form selected from a group consisting of ground, powdered, crunchy, smooth, paste, whole, crushed, broken, mixed, blended, and slurry;
placing said nut base and said flavor base in a mixing machine;
selecting a blend duration and a blend temperature of said mixing machine; and
blending said nut base with said flavor base in said mixing machine to form the nut milk blend.

18. The method of claim 17, wherein said flavor sweetener is from about 30% to about 90% of said flavor base and is selected from a group consisting of one or more of a chocolate, a vanilla, a matcha, a coconut, a cinnamon, a salted caramel, a ginger, a flaxseed, a cocoa, a monk fruit sugar, a coconut sugar, a cocoa nib, pink Himalayan salt, coconut milk, cacao nibs, cacao powder, mucuna seed powder, turmeric, black pepper, coffee, chamomile extract, strawberry powder, acai berry powder, elderberry powder, goji berry powder, and a date sugar.

19. The method of claim 18, wherein said nutrition supplement is from about 5% to about 65% of said flavor base and is selected from a group consisting of one or more of a lion's mane mushroom, a chlorella, a spirulina, a maca root, an ashwagandha root, a cordyceps mushroom, a chaga mushroom, a tocotrienols, a tocophorels, a reishi mushroom, an astragalus root, a chamomile, an L-Theanine, and a mucuna seed.

20. The method of claim 19, wherein said vitamin/mineral is from about 4% to about 10% of said flavor base and is selected from a group consisting of one or more of vitamin D, probiotic, vitamin C, magnesium, zinc, vitamin B, calcium, digestive enzymes, fiber, phosphorus, potassium, sodium, chloride, iron, iodine, sulfur, cobalt, copper, fluoride, manganese, calcium citrate, magnesium glycinate, vitamin D3, vitamin K2, zinc oxide, thiamin, niacin, vitamin B6, vitamin B12, vitamin E, and selenium.
